(19) United States
(12) Patent Application Publication
(10) Pub. No.: US 2025/0308800 A1
(43) Pub. Date: Oct. 2, 2025

(54) MULTILAYER CERAMIC ELECTRONIC COMPONENT, METHOD OF PRODUCING SAME, CIRCUIT MODULE, AND ELECTRONIC DEVICE

(71) Applicant: TAIYO YUDEN CO., LTD., Tokyo (JP)

(72) Inventor: Wakaaki MURAI, Tokyo (JP)

(21) Appl. No.: 19/066,838

(22) Filed: Feb. 28, 2025

(30) Foreign Application Priority Data
Mar. 29, 2024 (JP) 2024-056456

(51) Int. Cl. H01G 4/30; H01G 4/008; H01G 4/12

(52) U.S. Cl. CPC H01G 4/30; H01G 4/0085; H01G 4/1227

(57) ABSTRACT

A multilayer ceramic electronic component that can achieve both high capacitance and high reliability, and a method of producing the same are provided. A multilayer ceramic electronic component includes a plurality of dielectric layers laminated along first axis, a plurality of internal electrode layers each positioned between dielectric layers adjoining along first axis, and oxide layers positioned between dielectric layers and internal electrode layers. Dielectric layers contain a compound having perovskite structure represented by general formula ABO_{3-α} (0≤α>1). Internal electrode layers contain nickel and copper. Content of copper with respect to nickel in internal electrode layers is ≥0.5 at % and ≤8.5 at %. Content of nickel in oxide layers with respect to content of nickel in internal electrode layers is ≤90 at %. Content of oxygen in oxide layers with respect to content of oxygen in dielectric layers is ≤90 at %. Average thickness of oxide layers is ≥1.5 nm and ≤3.7 nm.

### CROSS-REFERENCE TO RELATED APPLICATION

The present application claims priority under 35 U.S.C. § 119 to Japanese Patent Application No. 2024-056456, filed Mar. 29, 2024, the contents of which are incorporated herein by reference in their entireties.

### BACKGROUND OF THE INVENTION

### Field of the Invention

This disclosure relates to a multilayer ceramic electronic component, a method of producing the same, a circuit module, and an electronic device.

### Description of the Related Art

Multilayer ceramic electronic components, such as multilayer ceramic capacitors (MLCCs), have been developed for being mounted on various electronic devices, such as smartphones, personal computers, and the like.

In many existing multilayer ceramic electronic components, internal electrode layers are mainly composed of nickel (Ni), and dielectric layers are mainly composed of barium titanate (BT). According to a method known as a method for producing a multilayer ceramic electronic component, for example, a dispersion in which metal particles, such as nickel (Ni), barium titanate (BT), and the like, are mixed and dispersed, together with an organic binder, in an organic solvent is deposited as films and laminated, and the laminate is then heated at a temperature of 1,000° C. or lower to remove any excess organic binder, and then fired in a reducing atmosphere in order to inhibit oxidation of Ni, which is a constituent of the internal electrode layers.

In multilayer ceramic electronic components, internal electrode layers and dielectric layers are required to have closely adhered to each other after being fired. For example, Japanese Patent Application Laid-Open Publication No. 2006-332572 discloses that a multilayer ceramic capacitor, which is formed of dielectric layers and internal electrode layers that are laminated alternately, and in which the internal electrode layers contains: a main component composed of Ni and Cu, or an alloy thereof; at least one type selected from the group consisting of Group-3B to Group-6B elements in the periodic table; and at least one type selected from Mn, Co, and Fe, is inhibited from generation of discontinuous parts in the conductor pattern through firing.

Multilayer ceramic electronic components are also required to have adaptability to a higher capacitance and high-temperature load reliability. For example, Japanese Patent Application Laid-Open Publication No. 2022-081390 discloses that a multilayer electronic component including: a main body including dielectric layers and internal electrodes laminated alternately across the dielectric layers; and external electrodes situated on the main body and connected to the internal electrodes, wherein the internal electrodes contain Cu and Ni, and a CV value (Coefficient of Variation) of Cu/Ni (weight ratio) in a region of the internal electrodes that is at 5 nm from the interface with the dielectric layers is 25.0% or less, achieves high capacitance and has high-temperature load reliability.

### SUMMARY OF THE INVENTION

In an existing method for producing a multilayer ceramic electronic component, when an organic binder contained in the internal electrode layers and the dielectric layers is degreased in the open-air atmosphere, the metal particles in the internal electrode layers are partially oxidized during the degreasing, causing a decrease in both the capacitance and the high-temperature load reliability of the multilayer ceramic electronic component, which is problematic.

It is an object of the present disclosure to provide a multilayer ceramic electronic component that can achieve both high capacitance and high reliability, and a method of producing a multilayer ceramic electronic component.

According to one embodiment of the present disclosure, a multilayer ceramic electronic component includes:
a plurality of dielectric layers laminated along a first axis;
a plurality of internal electrode layers each positioned between those of the dielectric layers that adjoin each other along the first axis; and
oxide layers positioned between the dielectric layers and the internal electrode layers,
wherein the dielectric layers contain a compound represented by a general formula ABO_{3-α} (0≤α≤1) and having a perovskite structure,
the internal electrode layers contain nickel and copper, and a content of the copper with respect to the nickel in the internal electrode layers is 0.5 at % or greater and 8.5 at % or less,
a content of nickel in the oxide layers with respect to a content of the nickel in the internal electrode layers is 90 at % or less, and a content of oxygen in the oxide layers with respect to a content of oxygen in the dielectric layers is 90 at % or less, and
an average thickness of the oxide layers is 1.5 nm or greater and 3.7 nm or less.

According to the present disclosure, it is possible to provide a multilayer ceramic electronic component that can achieve both high capacitance and high reliability, and a method of producing a multilayer ceramic electronic component.

### BRIEF DESCRIPTION OF THE DRAWINGS

FIG. 1 is a partially sectioned oblique view illustrating a multilayer ceramic capacitor according to an embodiment of the present disclosure;

FIG. 2 is a cross-sectional view illustrating a cross-section cut along a line A-A of FIG. 1;

FIG. 3 is a cross-sectional view illustrating a cross-section cut along a line B-B of FIG. 1;

FIG. 4 is an enlarged view of a cross-section of a part of dielectric layers, internal electrode layers, and oxide layers in a region D of an element body 10 of FIG. 3;

FIG. 5 is a view explaining a method for identifying an oxide layer;

FIG. 6 is a flowchart of a method of producing a multilayer ceramic capacitor according to an embodiment of the present disclosure;

FIG. 7A is a view illustrating an internal electrode layer pattern forming step of a method of producing a multilayer ceramic capacitor according to an embodiment of the present disclosure;

FIG. 7B is a view illustrating a laminate forming step of a method of producing a multilayer ceramic capacitor according to an embodiment of the present disclosure; and

FIG. 8 is an example of measurement results of a three-dimensional atom probe analysis.

### DETAILED DESCRIPTION OF THE DISCLOSURE

In the present specification and the drawings, components having substantially the same functional configuration may be omitted from repeated descriptions by assigning the same reference numerals. In the present specification and the drawings, the number, position, size, shape, and the like of each component are not limited to what are specified in an embodiment of the present disclosure, and may be any number, position, size, shape, and the like that are favorable for an embodiment of the present disclosure. In the drawings, an X axis, a Y axis, and a Z axis that are mutually orthogonal are shown where appropriate. The X axis, Y axis, and Z axis define a fixed coordinate system that is fixed to a multilayer ceramic capacitor, which is an example of a multilayer ceramic electronic component. When the outer shape of a multilayer ceramic capacitor, which is an example of the multilayer ceramic electronic component, is an approximate rectangular parallelepiped, the X axis, Y axis, and Z axis can correspond to the length, width, and height of the approximate rectangular parallelepiped. Hereinafter, using a multilayer ceramic capacitor, which is an example of the multilayer ceramic electronic component, the multilayer ceramic electronic component of this embodiment and a method of producing a multilayer ceramic electronic component of this embodiment will be described.

In this specification, the term “to” indicating a numerical range means to include the values specified before and after the term as the lower limit and the upper limit, unless otherwise particularly noted.

### Multilayer Ceramic Electronic Component

The multilayer ceramic electronic component of this embodiment includes a plurality of dielectric layers laminated along a first axis, a plurality of internal electrode layers positioned between those of the dielectric layers that adjoin each other along the first axis, and oxide layers positioned between the dielectric layers and the internal electrode layers. The multilayer ceramic electronic component of this embodiment may further include other layers or members as necessary.

### (1) Structure of Multilayer Ceramic Electronic Component

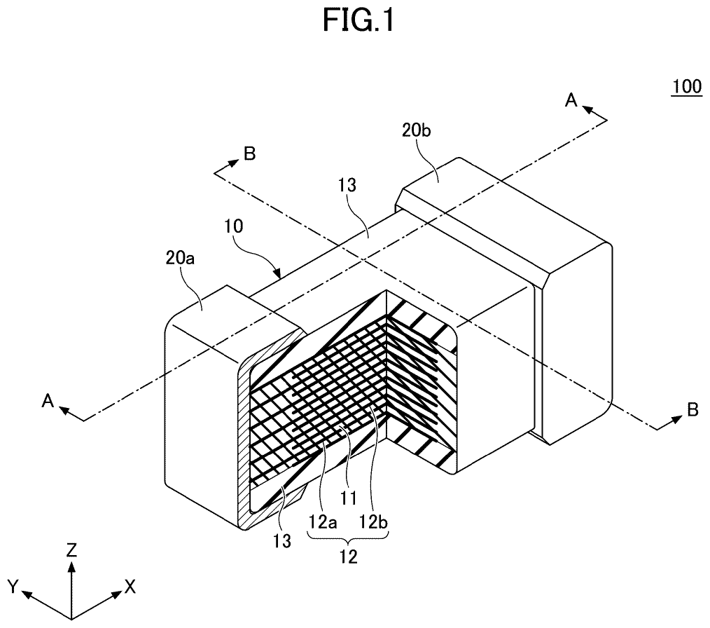

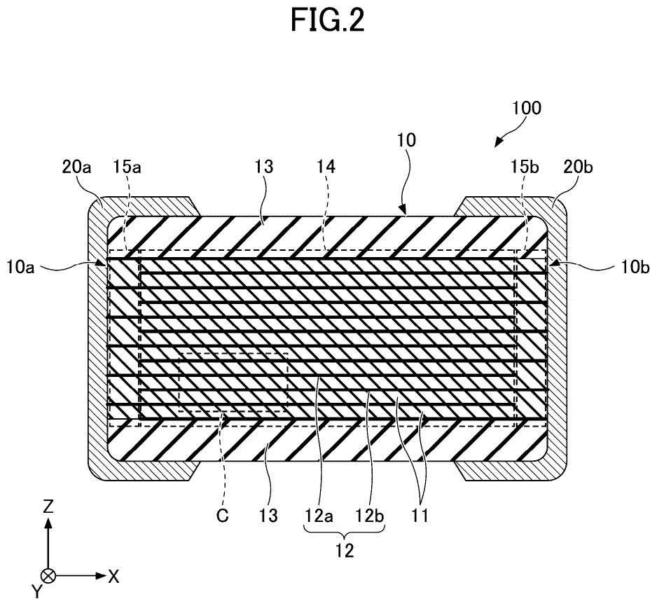

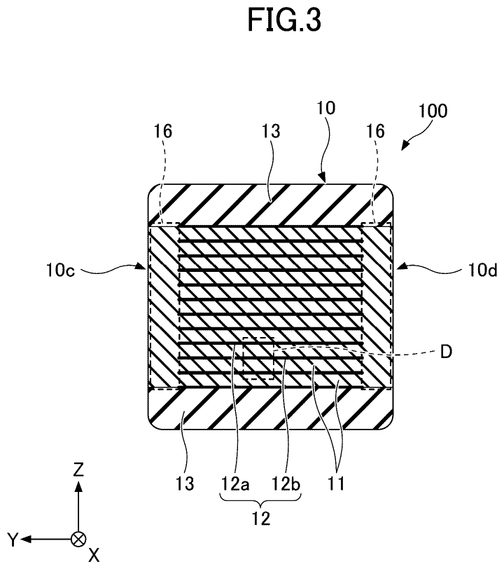

FIG. 1 is a partially sectioned oblique view illustrating a multilayer ceramic capacitor 100. FIGS. 2 and 3 are cross-sectional views illustrating the multilayer ceramic capacitor. FIG. 2 is a cross-sectional view illustrating a cross-section cut along a line A-A of FIG. 1. FIG. 3 is a cross-sectional view illustrating a cross-section cut along a line B-B of FIG. 1.

The multilayer ceramic capacitor 100 includes an element body 10 having a substantially rectangular parallelepiped shape, a first external electrode 20a, and a second external electrode 20b.

Two surfaces of the element body 10, among surfaces thereof, that face each other are referred to as an upper surface and a lower surface, and four surfaces connecting the upper surface and the lower surface are referred to as side surfaces. Normally, a surface of a multilayer ceramic capacitor that is on circuit board side is referred to as a lower surface, when mounting the capacitor on the circuit board. However, this is non-limiting. In the example shown in FIGS. 1 to 3, the first external electrode 20a and the second external electrode 20b are provided on a first side surface 10a and a second side surface 10b (see FIG. 2), which are two side surfaces of the element body 10 facing each other. The first external electrode 20a extends from the first side surface 10a to four adjacent surfaces. The second external electrode 20b extends from the second side surface 10b to four adjacent surfaces. However, the first external electrode 20a and the second external electrode 20b are spaced apart from each other. The external electrodes may be provided on anywhere other than the two facing side surfaces, as long as it is on a surface of the element body 10.

The lamination direction in which the dielectric layers 11 and the internal electrode layers 12 are laminated is the first axis. In FIGS. 1 to 3, the first axis, which is the lamination direction of the dielectric layers 11 and the internal electrode layers 12, is the Z axis, and is a direction in which the internal electrode layers face each other.

An axis which is perpendicular to the first axis, which is the lamination direction, is a second axis. In FIGS. 1 to 3, the second axis perpendicular to the first axis, which is the lamination direction, is the X axis. The second axis is an axis that is along the length direction of the element body 10, and is along a direction in which the first side surface 10a and the second side surface 10b of the element body 10 face each other, and along a direction in which the first external electrode 20a and the second external electrode 20b face each other.

An axis which is perpendicular to the first axis, which is in the lamination direction, and is also perpendicular to the second axis, is a third axis. The third axis is an axis that is along the width of the internal electrode layers 12. In FIGS. 1 to 3, the third axis that is perpendicular to the first axis, which is the lamination direction, and is also perpendicular to the second axis, is the Y axis, and is an axis that is along a direction in which a third side surface 10c and a fourth side surface 10d, which are two side surfaces other than the first side surface 10a and the second side surface 10b among the four side surfaces the element body 10, face each other (see FIG. 3). The X axis, the Y axis, and the Z axis are orthogonal to one another.

The lamination direction is not limited to the Z axis direction, and can be any direction. Therefore, for example, the first axis, which is the lamination direction, may be the X axis in the X direction or the Y axis in the Y direction.

In the present disclosure, in order to describe general embodiments, a drawing illustrating one specific embodiment among the embodiments may be used. However, the contents described based on the coordinate system used in the one embodiment are applicable to the general embodiments by reading the coordinate system of the one embodiment as a general coordinate system in which the lamination direction is along the first axis. For example, those that are used in FIGS. 1 to 3 relating to the one specific embodiment in which the lamination direction coincides with the Z axis direction and that are described as the X axis, Y axis, and Z axis are applicable to the general embodiments by reading them as the second axis, the third axis, and the first axis.

The element body 10 has a configuration in which the dielectric layers 11 containing a ceramic material functioning as a dielectric material and the internal electrode layers 12 are laminated alternately. The internal electrode layers 12 include a plurality of first internal electrode layers 12a and a plurality of second internal electrode layers 12b. The first internal electrode layers 12a and the second internal electrode layers 12b are laminated alternately. The edges of the first internal electrode layers 12a are drawn out to a surface of the element body 10 on which the first external electrode 20a is provided, which is the first side surface 10a in the example of FIGS. 1 to 3. The edges of the second internal electrode layers 12b are drawn out to a surface of the element body 10 on which the second external electrode 20b is provided, which is the second side surface 10b in the example of FIGS. 1 to 3. Thus, the first internal electrode layers 12a and the second internal electrode layers 12b are in alternate electrical conduction to the first external electrode 20a and the second external electrode 20b. Therefore, the multilayer ceramic capacitor 100 has a configuration in which capacitor units are laminated. In the laminate of the dielectric layers 11 and the internal electrode layers 12, internal electrode layers 12 are positioned on the outermost layers in the lamination direction, and the outer surfaces of the laminate in the lamination direction, which are the upper surface and the lower surface in the example of FIGS. 1 to 3, are covered by a cover layer 13. The cover layer 13 is mainly composed of a ceramic material. For example, the cover layer 13 may have a composition that is the same as or different from the dielectric layers 11. The configuration shown in FIGS. 1 to 3 is non-limiting except that the first internal electrode layers 12a and the second internal electrode layers 12b are exposed to different regions among the surfaces of the laminate and are in electrical conduction with different external electrodes. The different regions among the surfaces of the laminate may be surface regions included in facing surfaces of the laminate, respectively, may be surface regions included in adjacent surfaces of the laminate, respectively, or may be different surface regions included in the same surface of the laminate. As long as the different external electrodes are spaced apart from each other, the external electrodes may extend from the surfaces of the laminate, which include the surface regions to which the first internal electrode layers 12a and the second internal electrode layers 12b are exposed, to any other surface.

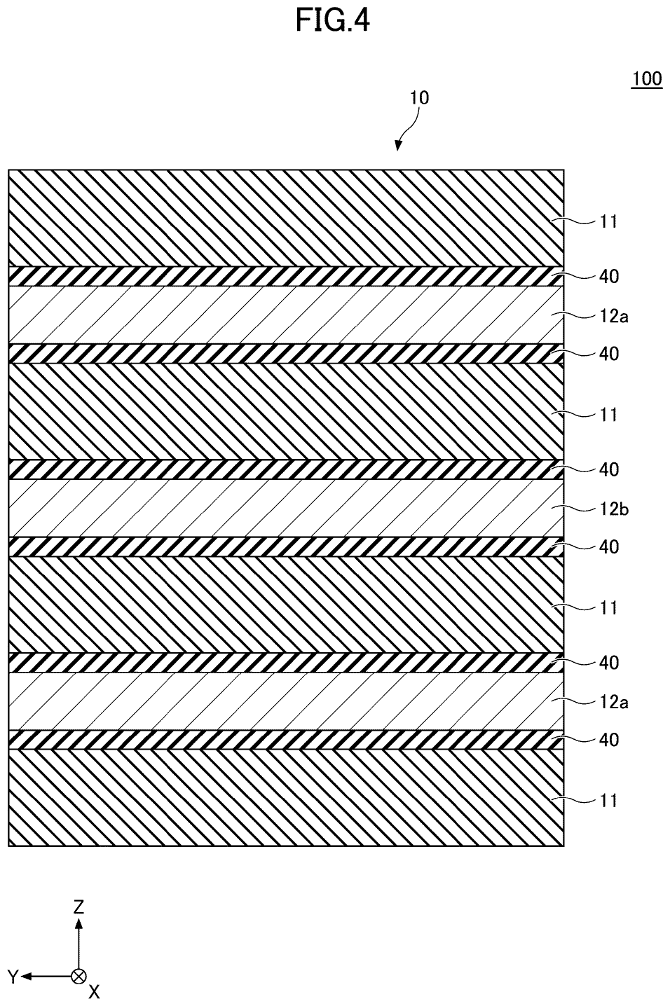

The element body 10 includes a plurality of oxide layers 40 (see FIG. 4) between the dielectric layers 11 and the internal electrode layers 12, which will be described in detail later. In FIGS. 1 to 3, description of the oxide layers 40 is omitted.

The size of the multilayer ceramic capacitor 100 is not particularly limited. For example, the length may be 0.25 mm, the width may be 0.125 mm, and the height may be 0.125 mm. The length may be 0.4 mm, the width may be 0.2 mm, and the height may be 0.2 mm. The length may be 0.6 mm, the width may be 0.3 mm, and the height may be 0.3 mm. The length may be 1.0 mm, the width may be 0.5 mm, and the height may be 0.5 mm. The length may be 3.2 mm, the width may be 1.6 mm, and the height may be 1.6 mm. The length may be 4.5 mm, the width may be 3.2 mm, and the height may be 2.5 mm. The sizes of the multilayer ceramic capacitor 100 listed above are only examples, and the multilayer ceramic capacitor is not limited to the above sizes. The sizes of the multilayer ceramic capacitor 100 may be in the relationship of, for example, length>width≥height, width>length≥height, height>length≥width, or height>width≥length. For example, the length represents the size in the X axis direction, the width represents the size in the Y axis direction, and the height represents the size in the Z axis direction.

As described above, the multilayer ceramic capacitor 100 of this embodiment includes the plurality of dielectric layers 11 laminated along the Z axis, which is the first axis, and the plurality of internal electrode layers 12 each positioned between those of the dielectric layers 11 that adjoin each other along the first axis. Furthermore, the multilayer ceramic capacitor 100 of this embodiment includes the oxide layers 40 positioned between the dielectric layers 11 and the internal electrode layers 12. The dielectric layers 11, the internal electrode layers 12, and the oxide layers 40 will be described below.

### (2) Dielectric Layers

The dielectric layers 11 contain a compound having a perovskite structure represented by a general formula ABO_{3-α} (0≤α≤1).

### (2-1) Components Contained in Dielectric Layers

### Compound Having Perovskite Structure

When having a stoichiometric composition, a compound having a perovskite structure is represented by a general formula ABO₃, with α, which represents the amount of deviation from the stoichiometric composition, being 0. The compound having a perovskite structure represented by the general formula may have a that is greater than 0 and 1 or less. That is, the compound having a perovskite structure represented by the general formula may have oxygen deficiency with respect to the stoichiometric composition.

In the general formula ABO_{3-α}, “A” is preferably one or more elements selected from the group consisting of Ba (barium), Sr (strontium), Ca (calcium), and Mg (magnesium). In the above general formula ABO_{3-α}, “B” is preferably one or more elements selected from the group consisting of Ti (titanium), Zr (zirconium), and Hf (hafnium). In the compound having the perovskite structure represented by the general formula ABO_{3-α}, the elements “A” and “B” are positioned at the A site and the B site of the perovskite structure, respectively.

As specific examples of the compound having the perovskite structure, one or more compounds selected from the group consisting of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Z_{z}O₃ (0≤x≤1, 0≤y≤1, 0≤z≤1) forming the perovskite structure can be used.

Examples of Ba_{1-x-y}CaₓSr_{y}Ti_{1-z}Z_{z}O₃ include barium strontium titanate, barium calcium titanate, barium zirconate, barium zirconate titanate, calcium zirconate titanate, barium calcium zirconate titanate, and the like. The compound having the perovskite structure may contain oxygen deficiency regardless of whatever material it is.

It is preferable that the dielectric layers 11 contain barium titanate as the compound having the perovskite structure because barium titanate has particularly excellent dielectric properties. The dielectric layers 11 may contain barium titanate as a main component, or may be composed only of barium titanate. Barium titanate has excellent dielectric properties such as extremely high relative permittivity and a small dielectric loss. Therefore, when the dielectric layers 11 contain barium titanate as the compound having a perovskite structure, the capacitance of the multilayer ceramic capacitor 100 can be increased.

As used herein, the term “main component” means the component contained the most in terms of the ratio by number of moles, among the components contained.

The dielectric layers 11 may contain the compound having a perovskite structure as a main component. The dielectric layers 11 may contain the compound having a perovskite structure by, for example, 50 mol % or greater, or by 90 mol % or greater, and may consist only of the compound having a perovskite structure.

### Additives

The dielectric layers 11 may contain additives as optional components.

The additives contained in the dielectric layers 11 are not particularly limited, and examples include: oxides containing zirconium (Zr), magnesium (Mg), manganese (Mn), molybdenum (Mo), vanadium (V), chromium (Cr), and rare earth elements (one or more elements selected from the group consisting of scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)); oxides containing one or more elements selected from the group consisting of cobalt (Co), nickel (Ni), lithium (Li), boron (B), sodium (Na), potassium (K), and silicon (Si); glass containing one or more elements selected from the group consisting of cobalt, nickel, lithium, boron, sodium, potassium, and silicon; and the like.

### (2-2) Average Thickness of Dielectric Layers

The average thickness of the dielectric layers 11 is not particularly limited, yet is, for example, preferably 1.0 μm or less, and more preferably 0.8 μm or less in order to increase the capacitance by increasing the number of laminated layers while reducing the size of the multilayer ceramic capacitor 100. The average thickness of the dielectric layers 11 is, for example, preferably 0.2 μm or greater, and more preferably 0.4 μm or greater in order to increase productivity and yield. The lower limit and the upper limit of the average thickness of the dielectric layers 11 can be appropriately combined, and the average thickness of the dielectric layers 11 is preferably 0.2 μm or greater and 1.0 μm or less, and more preferably 0.4 μm or greater and 0.8 μm or less.

When evaluating the average thickness of the dielectric layers 11, as shown in FIGS. 1 and 2, the multilayer ceramic capacitor 100 is polished along the Y axis, and polished to the center on the Y axis, to prepare a sample that exposes an XZ surface in which the dielectric layers 11 and the internal electrode layers 12 are laminated. From the exposed XZ surface, two dielectric layers 11 located in the center on the Z axis, which is the first axis, are selected, and two dielectric layers 11 located on each of the upper and lower ends on the Z axis, which is the first axis, are selected. Here, the dielectric layers 11 to be selected are selected from within a capacitive part 14.

Then, the thickness of a selected dielectric layer 11 is measured at the center on the X axis, which is the second axis, and used as the thickness of the dielectric layer 11. By the same procedure, the dielectric layer 11 thickness of all of the selected six dielectric layers 11 is measured, and an average value is calculated. This average value is obtained as the average thickness of the dielectric layers 11 of the multilayer ceramic capacitor 100. The thickness of the dielectric layers 11 can be measured by, for example, a Scanning Electron Microscope (SEM) or a Scanning Transmission Electron Microscope (STEM). Since the dielectric layers 11 and the internal electrode layer 12 have different compositions, they can be distinguished from each other by differences in luminance when observed in an electron beam image.

### (3) Internal Electrode Layers

### (3-1) Components Contained in Internal Electrode Layers

As illustrated in FIG. 2, the region where the first internal electrode layers 12a connected to the first external electrode 20a and the second internal electrode layers 12b connected to the second external electrode 20b face each other is a region where electric capacitance is generated in the multilayer ceramic capacitor 100. Therefore, the region where the electric capacitance is generated is referred to as the capacitive part 14. That is, the capacitive part 14 is a region where the internal electrode layers connected to the different external electrodes and adjoining each other across the dielectric layers face each other.

The region where the first internal electrode layers 12a connected to the first external electrode 20a face each other in the lamination direction via nor second internal electrode layer 12b connected to the second external electrode 20b is referred to as a first end margin 15a. The region where the second internal electrode layers 12b connected to the second external electrode 20b face each other in the lamination direction via no first internal electrode layer 12a connected to the first external electrode 20a is referred to as a second end margin 15b. Each end margin is a region where the internal electrode layers connected to the same external electrode face each other in the lamination direction via no internal electrode layers connected to the different external electrode. The first end margin 15a and the second end margin 15b are regions where no electric capacitance is generated.

Side margins 16 are regions provided on the outer side of the capacitive part 14 in a direction along the third axis perpendicular to the lamination direction and perpendicular to the second axis, which is the Y axis in the example of FIG. 3. That is, the side margin 16 are outer regions adjacent to the capacitive part 14 when viewed from in lamination direction, and outer regions adjacent to the capacitive part 14 on the sides to which the internal electrode layers 12 are not drawn out. The side margins 16 are also regions in which no electrical capacitance is generated.

The internal electrode layers 12 contain nickel (Ni) and copper (Cu). As the content of copper in the internal electrode layers 12, the content of copper (Cu) with respect to nickel (Ni) is 0.5 at % or greater and 8.5 at % or less in order to realize high capacitance, preferably 0.5 at % or greater and 6.0 at % or less, and more preferably 1.0 at % or greater and 6.0 at % or less in order to achieve both high capacitance and high reliability. The content of copper with respect to nickel is a ratio by number of copper atoms when nickel is regarded as 100 at %.

In addition to nickel (Ni) and copper (Cu), the internal electrode layers 12 can contain other components typically used in internal electrode layers of multilayer ceramic capacitors. Examples of other components used in internal electrode layers of multilayer ceramic capacitors include: base metals such as tin (Sn) and the like or alloys containing the same; noble metals such as platinum (Pt), palladium (Pd), silver (Ag), gold (Au), and the like or alloys containing the same; and the like. One of these components may be used alone, or two or more may be used in combination.

The internal electrode layers 12 may contain nickel, copper, and any of the above-specified components used in internal electrode layers of multilayer ceramic capacitors as a main component. Yet, it is preferable that the internal electrode layers 12 contain nickel as the main component because it has excellent electrical characteristics and can save cost.

The main component of the first internal electrode layers 12a and the main component of the second internal electrode layers 12b may be the same or different. As an example, the main component of the first internal electrode layers 12a and that of the second internal electrode layers 12b may both be nickel and the same as each other, or may both be copper and the same as each other.

The contents of nickel, copper, and other components in the internal electrode layers 12 can be confirmed by performing an elemental analysis of the internal electrode layers 12 using various measuring instruments and calculating the ratio of each component by number of atoms with respect to all detected elements. As the measuring instrument for the elemental analysis, an Energy Dispersive X-ray Spectrometer (EDS) or a Wavelength Dispersive X-ray Spectrometer (WDS) mounted on a Scanning Electron Microscope (SEM) or a Scanning Transmission Electron Microscope (STEM), an Electron Probe Micro Analyzer (EPMA), a Laser Ablation-Inductively Coupled Plasma-Mass Spectrometer (LA-ICP-MS), or the like can be used.

### (3-2) Average Thickness of Internal Electrode Layers

The average thickness of the internal electrode layers 12 is not particularly limited, yet is, for example, preferably 0.8 μm or less and more preferably 0.6 μm or less, in order to increase the capacitance by increasing the number of laminated layers while reducing the size of the multilayer ceramic capacitor 100. The average thickness of the internal electrode layers 12 is, for example, preferably 0.2 μm or greater, and more preferably 0.4 μm or greater, from the viewpoint of improving productivity and yield. The lower limit and the upper limit of the average thickness of the internal electrode layers 12 can be appropriately combined. The average thickness of the internal electrode layers 12 is preferably 0.2 μm or greater and 0.8 μm or less, and more preferably 0.4 μm or greater and 0.6 μm or less.

When evaluating the average thickness of the internal electrode layers 12, as shown in FIGS. 1 and 2, the multilayer ceramic capacitor 100 is polished along the Y axis, and polished to the center on the Y axis, to prepare a sample that exposes an XZ surface in which the dielectric layers 11 and the internal electrode layers 12 are laminated. From the exposed XZ surfaces, two internal electrode layers 12 located in the center on the Z axis, which is the first axis, are selected, and two internal electrode layers 12 located at each of the upper and lower ends on the Z axis, which is the first axis, are selected. Here, the internal electrode layers 12 to be selected are selected from within the capacitive part 14.

Then, the thickness of a selected internal electrode layer 12 is measured at the center on the X axis, which is the second axis, and used as the thickness of the internal electrode layer 12. By the same procedure, the internal electrode layers 12 thickness of all of the selected six internal electrode layers 12 is measured, and an average value is calculated. This average value is used as the average thickness of the internal electrode layers 12 of the multilayer ceramic capacitor 100. The thickness of the internal electrode layers 12 can be measured by, for example, a Scanning Electron Microscope (SEM) or a Scanning Transmission Electron Microscope (STEM).

### (4) Oxide Layers

### (4-1) Average Thickness of Oxide Layers

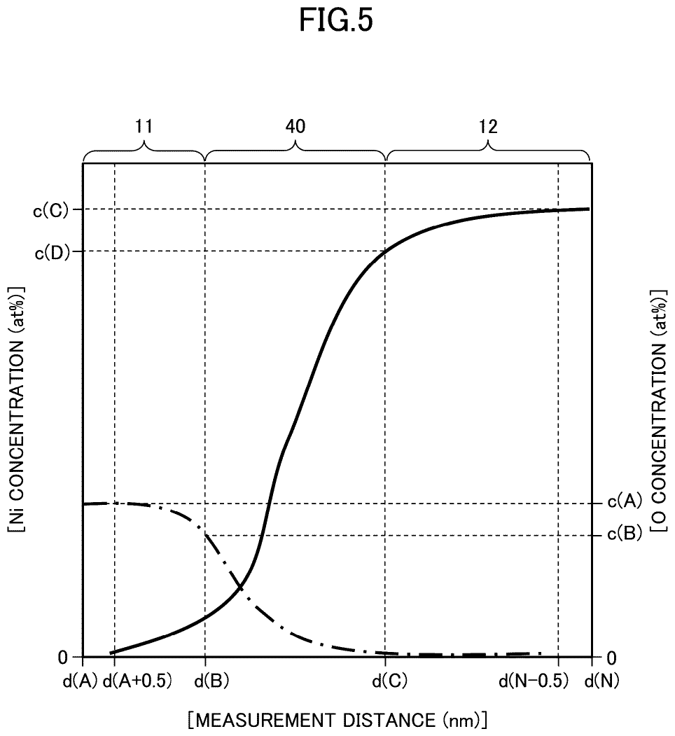

FIG. 4 is an enlarged view of a cross-section of a part of the dielectric layers 11, the internal electrode layers 12, and the oxide layers 40 in a region D of the element body 10 of FIG. 3. FIG. 5 is a view explaining a method for identifying the oxide layers.

The inventor of the present disclosure has carried out extensive studies and found it possible to achieve both high capacitance and high reliability, by positioning the oxide layers 40 having an average thickness of 1.5 nm or greater and 3.7 nm or less between the dielectric layers 11 and the internal electrode layers 12.

The oxide layers 40 are positioned between the dielectric layers 11 and the internal electrode layers 12, that is, at the boundary between the dielectric layers 11 and the internal electrode layers 12. The oxide layers 40 are observed using a three-dimensional atom probe (3DAP). The method for identifying the oxide layers 40 will be described with reference to FIGS. 1, 2, and 5, which are an example of the case where the main component of the internal electrode layers 12 is nickel.

As shown in FIGS. 1 and 2, the multilayer ceramic capacitor 100 is polished along the Y axis and polished to the center on the Y axis, to prepare a sample that exposes an XZ surface in which the dielectric layers 11 and the internal electrode layers 12 are laminated. From the exposed XZ surface, two dielectric layers 11 located in the center on the Z axis, which is the first axis, are selected, and two dielectric layers 11 located at each of the upper and lower ends on the Z axis, which is the first axis, are selected. Here, the dielectric layers 11 to be selected are selected from within the capacitive part 14.

Then, for each selected dielectric layer 11, a conical region having a bottom circle diameter of 50 nm to 200 nm and a height of 200 nm to 600 mn is cut out from a part including the dielectric layer 11-internal electrode layer 12 interface in the center on the X axis, which is the second axis, and prepared as a sample. An elemental analysis of this sample is performed by measuring the sample from the dielectric layer 11 side to the internal electrode layer 12 side using a three-dimensional atom probe.

In FIG. 5, the horizontal axis represents the measurement distance (nm) from the dielectric layer 11 side to the internal electrode layer 12 side. In FIG. 5, when the distance from a position A to an arbitrary position x is defined as a measurement distance d(x) [nm] where the position A is the position of an end on the dielectric layer 11 side from where the measurement is started, the measurement distance of the position A is represented as d(A) [nm]=0 [nm]. When the distance from the position A to a position N of an end on the internal electrode layer 12 side where the measurement is finished is defined as d(N) [nm], the position at the measurement distance d(N) [nm] is represented as d(N). The vertical axis represents Ni concentration (at %) or the 0 concentration (at %) measured by the three-dimensional atom probe.

Regarding the O concentration, an average value c(A) of the O concentration in a range from the position A of the end from where the measurement is started to a position (A+0.5) reached by bringing forward the measurement by 0.5 nm, that is, a range from the position at the measurement distance of d(A) [nm] to the position at the measurement distance of d(A+0.5) [nm] is calculated. Then, a concentration that is 90% the average value c(A) of the O concentration is defined as c(B). A position B having this concentration c(B) is a position at a measurement distance of d(B) [nm], and this position B is defined as the boundary between the dielectric layer 11 and the oxide layer 40, and is referred to as an “interface I”.

Regarding the Ni concentration, an average value c(C) of the Ni concentration in a range from the position N of the end at which the measurement is finished to a position (N−0.5) reached by returning to the dielectric layer 11 side by 0.5 nm, that is, a range from the position at the measurement distance d(N) [nm] to the position at the measurement distance d(N−0.5) [nm] is calculated. Then, a concentration that is 90% the average value c(C) of the Ni concentration is defined as c(D). A position C having this concentration c(D) is a position at a measurement distance d(C) [nm], and this position C is defined as the boundary between the oxide layer 40 and the internal electrode layer 12, and is referred to as an “interface II”.

In the present disclosure, the oxide layer 40 refers to a region between the interface I and the interface II. Therefore, the measurement distance (nm) between the interface I and the interface II corresponds to the thickness of the oxide layer 40. By the same procedure, the thickness of the oxide layer 40 is measured for the boundaries between all of the selected six dielectric layers 11 and internal electrode layers 12, and the average value is calculated. This average value is used as the average thickness of the oxide layers 40 of the multilayer ceramic capacitor 100.

The average thickness of the oxide layers 40 is 1.5 nm or greater and 3.7 nm or less, preferably 2.0 nm or greater and 3.7 nm or less in order to realize high capacitance, and more preferably 2.0 nm or greater and 3.45 nm or less in order to achieve both high capacitance and high reliability.

### (4-2) Components Contained in Oxide Layers

The oxide layers 40 contain an oxide, and the content of nickel in the oxide layer 40 with respect to the content of nickel in the internal electrode layers 12 is 90 at % or less, and the content of oxygen in the oxide layers 40 with respect to the content of oxygen in the dielectric layers 11 is 90 at % or less. The valence of the oxide ion of the oxide is not particularly limited, and examples of the oxide ion include monovalent ion, divalent ion, and the like. The content of nickel in the internal electrode layers 12, the content of nickel in the oxide layers 40, the content of oxygen in the dielectric layers 11, and the content of oxygen in the oxide layers 40 can be measured by the above-described three-dimensional atom probe.

The oxide in the oxide layers 40 contains at least oxygen. The oxygen in the oxide layers 40 may bond with at least one selected from the group consisting of nickel and copper contained in the internal electrode layers 12. That is, the oxide layers 40 may contain nickel oxide or may contain copper oxide. In addition, when the internal electrode layers 12 contain any other component used in internal electrode layers of multilayer ceramic capacitors, the oxide layers 40 may contain a component bonding with the any other component.

The multilayer ceramic capacitor 100 includes the oxide layers 40 containing nickel and copper between the internal electrode layers 12 and the dielectric layers 11. Since FIG. 4 is a schematic view, the oxide layers 40 are illustrated as continuous layers having a constant thickness. However, this configuration is non-limiting. As long as the average thickness of the oxide layers 40 is 1.5 nm or greater and 3.7 nm or less, for example, the oxide layers 40 may be discontinuous, and or may have a different thickness depending on the position.

The multilayer ceramic electronic component of this embodiment can be suitably produced by a method of producing a multilayer ceramic electronic component of this embodiment described later.

The multilayer ceramic electronic component of this embodiment can achieve both high capacitance and high reliability. From this viewpoint, it is preferable that the mean time to failure of twenty multilayer ceramic electronic components of this embodiment, measured by an accelerated life test in which a voltage of 9 V/μm is applied at 125° C., and the capacitance of the multilayer ceramic electronic component of this embodiment satisfy an expression 1 below, and it is more preferable that the value calculated by the left side of the expression 1 is 1,500 or greater.

Mean time to failure×(capacitance/100)²≥1,200 [Expression 1]

### Method of Producing Multilayer Ceramic Capacitor

A method of producing a multilayer ceramic electronic component according to the present embodiment includes an internal electrode layer pattern forming step, a laminate forming step, a first heating step, and a second heating step. The method of producing a multilayer ceramic electronic component according to the present embodiment may further include other steps such as a raw material powder preparation step, a slurry preparation step, a coating step, a compression bonding step, a singulation step, a re-oxidation treatment step, an external electrode forming step, a plating treatment step, and the like.

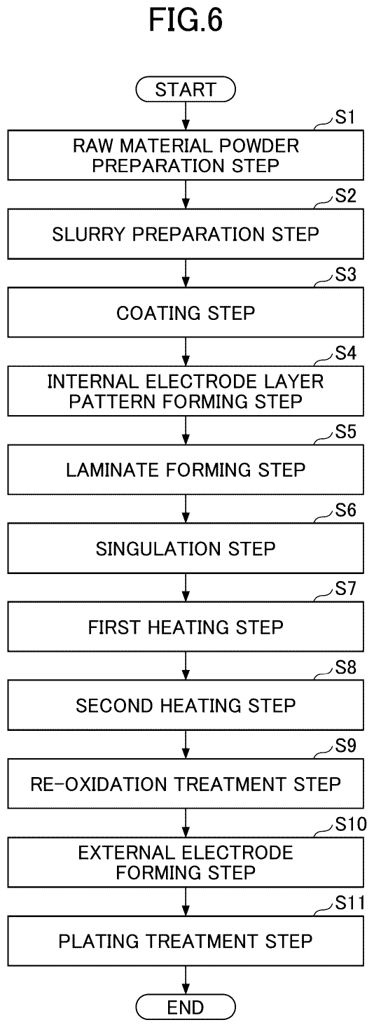

FIG. 6 is a flowchart illustrating the method of producing the multilayer ceramic capacitor 100.

Conventionally, inexpensive base metals such as Ni and the like that are used in internal electrode layers and the like of multilayer ceramic electronic components typically have a low equilibrium oxygen partial pressure, and therefore, there is a problem that they form oxides and their conductivity is reduced when fired at a high temperature in the open-air atmosphere. Therefore, firing is typically performed in a reducing atmosphere in order to inhibit oxidation of the metals contained in the internal electrode layers. Ceramics, on the other hand, require an organic binder when they are fired, in order to be provided with plasticity and shape retention property. This organic binder, if it has remained through firing, leads to a decrease in the capacitance, and needs to have been removed from the final product. From the viewpoint of removing the organic binder, it is desirable to fire ceramics in an oxidizing atmosphere. In addition, when the organic binder is degreased in the open-air atmosphere, the metal particles in the internal electrode layers are partially oxidized during the degreasing, leading to a problem that the capacitance and the high-temperature load reliability of the multilayer ceramic electronic components are reduced. As obvious from the above, the atmosphere condition for inhibiting oxidation of the metals as the firing condition in the production of multilayer ceramic electronic components, and the atmosphere condition for removing the organic binder are in a trade-off relationship.

The inventor of the present disclosure carried out extensive studies and found it possible to reduce the thickness of an oxide layer to be formed on an internal electrode layer and achieve thickness reduction of the layer by adding a specific amount of copper oxide, together with nickel and an organic binder, to a metal paste for forming an internal electrode layer pattern, and to produce a multilayer ceramic electronic component that can achieve both high capacitance and high reliability by further controlling the thickness of the oxide layer within a specific range. Although the mechanism behind the reduction in the thickness of the oxide layer to be formed on the internal electrode layer through addition of a specific amount of copper oxide in the metal paste for forming an internal electrode layer pattern is yet to be elucidated, it is considered that, since the free energy of copper to form an oxide is lower than the free energy of nickel to form an oxide, addition of a specific amount of copper, which is more easily reduced than nickel, in the form of an oxide to the metal paste, causes copper oxide to be reduced prioritizedly over nickel during firing, which inhibits formation of an oxide layer on the surface of the internal electrode layer containing nickel.

### (1) Raw Material Powder Preparation Step (S1)

In the raw material powder preparation step (S1), a raw material powder of a ceramic material serving as a dielectric material for forming the dielectric layers 11 is prepared. Since the dielectric layers 11 contain a compound having a perovskite structure represented by the general formula ABO_{3-α} (0≤α≤1), a material from which a ceramic material containing a compound having a perovskite structure represented by the general formula ABO_{3-α} can be obtained is used as the raw material powder of the ceramic material.

For example, barium titanate (BaTiO₃) is a tetragonal crystal compound having a perovskite structure and exhibits a high relative permittivity. Barium titanate can be typically obtained by reacting a titanium raw material such as titanium dioxide or the like with a barium raw material such as barium carbonate or the like.

Various methods have been known as the method for synthesizing raw material powders of ceramic materials, such as solid-phase methods, sol-gel methods, hydrothermal methods, and the like. In this embodiment, any of these methods can be employed.

The number average particle diameter of the raw material powder of the ceramic material is preferably 50 nm to 200 nm and more preferably 50 nm to 100 nm from the viewpoint of reducing the thickness of the dielectric layers 11.

In the raw material powder preparation step (S1), a predetermined additive can be added to the raw material powder of the ceramic material according to the intended purpose. Examples of additive compounds include: one or more elements selected from the group consisting of zirconium (Zr), niobium (Nb), molybdenum (Mo), tantalum (Ta), tungsten (W), magnesium (Mg), manganese (Mn), vanadium (V), and chromium (Cr); oxides containing one or more rare earth elements selected from the group consisting of scandium (Sc), yttrium (Y), cerium (Ce), neodymium (Nd), samarium (Sm), europium (Eu), gadolinium (Gd), terbium (Tb), dysprosium (Dy), holmium (Ho), erbium (Er), thulium (Tm), and ytterbium (Yb); oxides containing one or more elements selected from the group consisting of cobalt (Co), nickel (Ni), lithium (Li), boron (B), sodium (Na), potassium (K), and silicon (Si); glass containing one or more elements selected from the group consisting of cobalt (Co), nickel (Ni), lithium (Li), boron (B), sodium (Na), potassium (K), and silicon (Si); and the like. One of these may be used alone, or two or more may be used in combination. Among these, silicon dioxide (SiO₂), which is mainly an oxide of silicon (Si), functions favorably as a sintering aid.

In the raw material powder preparation step (S1), for example, the raw material powder of the ceramic material can be prepared by mixing, as needed, a compound containing an additive and an additive compound with the raw material powder of the ceramic material in a wet manner, and drying and grinding the resulting product. After drying and grinding, as needed, the raw material powder may be further subjected to, for example, a grinding treatment, to adjust the particle diameter, or further to a classification treatment in combination to adjust the particle diameter. Through the above step, the raw material powder as a dielectric material can be obtained.

### (2) Slurry Preparation Step (S2)

In the slurry preparation step (S2), a slurry containing the raw material powder obtained in the raw material powder preparation step (S1) is prepared.

The slurry may contain an organic binder, an organic solvent, a plasticizer, and the like in addition to the raw material powder obtained in the raw material powder preparation step (S1). The organic binder is not particularly limited, and a publicly-known resin such as polyvinyl butyral (PVB) resin or the like may be used. The organic solvent is not particularly limited, and examples include ethanol, toluene, and the like.

The method of preparing the slurry is not particularly limited, and an example is a method of adding together the raw material powder, the organic binder, the organic solvent, and the plasticizer, and mixing them in a wet manner. The organic binder and the like may be added together and mixed in a wet manner, when mixing the raw material powder of the ceramic material and like in the raw material powder preparation step (S1).

### (3) Coating Step (S3)

In the coating step (S3), the slurry obtained in the slurry preparation step (S2) is applied to a substrate.

In the coating step (S3), the obtained slurry can be applied to a substrate by, for example, a die coater method or a doctor blade method. As a result, a dielectric layer precursor sheet 71 is formed. An example of the dielectric layer precursor sheet 71 is a ceramic precursor sheet. The thickness of the dielectric layer precursor sheet 71 can be appropriately selected according to the intended average thickness of the dielectric layers 11.

Although the substrate is not particularly limited, it is preferable that the substrate is made of a material from which the dielectric layer precursor sheet 71 can be peeled, and an example of the material is polyethylene terephthalate (PET) film.

In the coating step (S3), the slurry may be dried after it is applied to the substrate. A diagram illustrating the coating step (S3) is omitted.

### (4) Internal Electrode Layer Pattern Forming Step (S4)

In the internal electrode layer pattern forming step (S4), using a metal paste containing nickel, copper oxide, and an organic binder, an internal electrode layer pattern 72 is formed on the dielectric layer precursor sheet 71 containing the raw material powder of the ceramic material containing a compound having a perovskite structure represented by the general formula ABO_{3-α} (0≤α≤1). Specifically, using a metal paste containing nickel (Ni), copper oxide (CuO), and an organic binder, an internal electrode layer pattern 72 is formed on the dielectric layer precursor sheet 71 obtained in the coating step (S3).

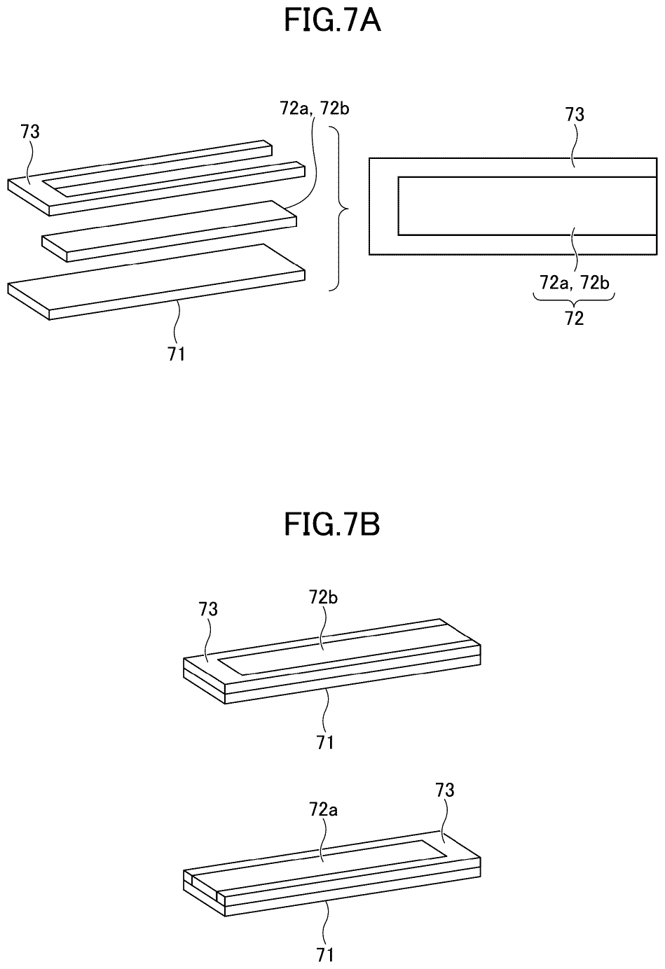

FIG. 7A is a diagram illustrating the internal electrode layer pattern forming step of the method of producing a multilayer ceramic capacitor according to an embodiment of the present disclosure.

The particle diameter of copper oxide (CuO) is not particularly limited, yet is preferably smaller than the thickness of the internal electrode layers 12, and is more preferably 10 nm to 100 nm from the viewpoint of reducing the thickness of the internal electrode layers 12.

Regarding the content of copper oxide (CuO) in the metal paste, from the viewpoint of realizing high capacitance, CuO is added such that the content of copper (Cu) with respect to nickel (Ni) is 0.5 at % or greater and 8.5 at % or less, and it is preferable to add CuO such that the content of copper (Cu) with respect to nickel (Ni) is 0.5 at % or greater and 6.0 at % or less in the final product. From the viewpoint of achieving both high capacitance and high reliability, it is more preferable to add CuO such that the content of copper (Cu) with respect to nickel (Ni) is 1.0 at % or greater and 6.0 at % or less. When adding copper oxide (CuO), CuO may be dispersed in an organic solvent such as terpineol or the like in advance.

As described above, the first internal electrode layers 12a and the second internal electrode layers 12b may contain nickel (Ni) or an alloy containing nickel (Ni) as a main component, and may contain copper (Cu). The metal paste may further contain: a base metal such as tin (Sn) and the like, or an alloy containing the same; and a noble metal such as platinum (Pt), palladium (Pd), silver (Ag), gold (Au), and the like, or an alloy containing the same.

In addition, ceramic particles may be added to the metal conductive paste as a co-existent material. The main component of the ceramic particles is not particularly limited, but is preferably the same as that of the main component ceramic material of the dielectric layer 11. The particle diameter of the ceramic particles as a co-existent material is not particularly limited, yet is preferably smaller than the thickness of the internal electrode layers 12, more preferably 10 nm to 100 nm from the viewpoint of reducing the thickness of the internal electrode layers 12, and yet more preferably 10 nm to 50 nm from the viewpoint of dispersibility of the composition.

An internal electrode layer pattern 72a for a first internal electrode layer 12a and an internal electrode layer pattern 72b for a second internal electrode layer 12b may be formed by using a metal paste of the same composition or may be formed by using metal pastes of different compositions as long as metal paste(s) containing nickel, copper oxide, and an organic binder is/are used. That is, the main component in the first internal electrode layers 12a and the main component in the second internal electrode layers 12b may be the same or different. As an example, both the first internal electrode layers 12a and the second internal electrode layers 12b may contain nickel as their main component.

In the internal electrode layer pattern forming step (S4), the metal paste can be prepared by kneading together, nickel, copper oxide, an organic binder, and, if necessary, other metals or alloys, or a co-existent material. Copper may be added in a simple substance state or in a compound state.

In the internal electrode layer pattern forming step (S4), as illustrated in FIG. 7A, the metal paste containing nickel, copper oxide, and an organic binder can be printed on the surface of the dielectric layer precursor sheet 71 by a printing method such as screen printing, gravure printing, and the like. Further, the method of forming the internal electrode layer pattern in the internal electrode layer pattern forming step (S4) is not limited to the printing method, and a plating method, a vacuum vapor deposition method, a sputtering method, a CVD method, or the like may be used. In this way, a first internal electrode layer pattern 72a for a first internal electrode layer 12a or a second internal electrode layer pattern 72b for a second internal electrode layer 12b is formed on the surface of the dielectric layer precursor sheet 71.

A dielectric pattern paste for a reverse pattern layer can be obtained by adding an organic binder such as ethyl cellulose or the like and an organic solvent such as terpineol or the like to the raw material powder obtained in the raw material powder preparation step (S1) and kneading them by a roll mill. As illustrated in FIG. 7A, the dielectric pattern paste may be formed on a peripheral region of the dielectric layer precursor sheet 71 where the first internal electrode layer pattern 72a or the second internal electrode layer pattern 72b is not formed, to provide a dielectric pattern 73 on the peripheral region and fill the gap from the first internal electrode layer pattern 72a or the second internal electrode layer pattern 72b. The dielectric layer precursor sheet 71 on which the internal electrode layer pattern 72 and the dielectric pattern 73 are formed is referred to a lamination unit.

### (5) Laminate Forming Step (S5)

In the laminate forming step (S5), a laminate is formed by laminating a plurality of layers of dielectric layer precursor sheets 71, on each of which the internal electrode layer pattern 72 is formed, along the first axis.

FIG. 7B is a diagram illustrating the laminate forming step of the method of producing a multilayer ceramic capacitor according to one embodiment of the present disclosure.

Specifically, as illustrated in FIG. 7B, a dielectric layer precursor sheet 71 on which the first internal electrode layer pattern 72a and the dielectric pattern 73 are formed and a dielectric layer precursor sheet 71 on which the second internal electrode layer pattern 72b and the dielectric pattern 73 are formed are laminated in this order, while peeling the substrates from the dielectric layer precursor sheets 71. Here, it is preferable to laminate the lamination units such that the internal electrode layers 12 and the dielectric layers 11 are alternate and such that the edges of the internal electrode layers 12 are exposed to the end surfaces of the dielectric layers 11 on alternate sides in the length direction and drawn out to alternate ones of a pair of external electrodes.

The number of lamination units to be laminated is not particularly limited and can be appropriately selected according to the purpose, and may be, for example, 100 layers to 500 layers.

Further, the cover layer 13 may be laminated on the upper and lower surfaces of the laminated product of the dielectric layer precursor sheets 71. The number of layers of the cover layer 13 to be laminated is not particularly limited and can be appropriately selected according to the purpose, and may be, for example, 2 layers to 10 layers.

In the laminate forming step (S5), the laminated product obtained as described above, preferably the laminated product of the dielectric layer precursor sheets 71 covered with the cover layer 13 on the upper and lower surfaces of the laminated product, can be thermo-compression bonded, to form a laminate.

### (6) Singulation Step (S6)

In the singulation step (S6), the laminate obtained in the laminate forming step (S5) is singulated into individual pieces.

In the singulation step (S6), the singulation method is not particularly limited, and existing methods such as dicing, laser cutting, and the like can be used.

The size into which the laminate is singulated is not particularly limited, and can be appropriately selected according to the desired size of the multilayer ceramic capacitor 100.

### (7) First Heating Step (S7)

In the first heating step (S7), the laminate obtained in the laminate forming step (S5) or the laminate singulated in the singulation step (S6) is heated at a temperature that is equal to higher than the degreasing temperature at which the organic binder is degreased and is lower than the firing temperature.

The heating temperature in the first heating step (S7) is not particularly limited as long as the temperature is equal to or higher than the organic binder degreasing temperature and is lower than the firing temperature, yet it is preferable to heat the laminate at 800° C. or higher and 1,000° C. or lower. The heating time in the first heating step (S7) is not particularly limited, yet it is preferable to retain the laminate heated for 3 minutes or longer and 5 minutes or shorter. Most of all, in the first heating step (S7), it is particularly preferable to retain the laminate at a temperature of 800° C. or higher and 1,000° C. or lower for 3 minutes or longer and 5 minutes or shorter from the viewpoint of reducing the thickness of the oxide layers 40 and achieving both high capacitance and high reliability.

Organic binders are typically burned to extinction at approximately 500° C. Therefore, the organic binder can be degreased in the first heating step (S7). In the first heating step (S7), the laminate may be subjected to mild temperature elevation until a temperature reaches the heating temperature equal to or higher than the organic binder degreasing temperature.

The oxygen partial pressure in the first heating step (S7) is not particularly limited, yet is preferably 10⁻¹² atm or higher and 10⁻⁷ atm or lower, more preferably 10⁻¹⁰ atm or higher and 10⁻⁷ atm or lower, and yet more preferably 10⁻⁸ atm or higher and 10⁻⁷ atm or lower.

A preferable atmosphere condition in the first heating step (S7) is a reducing atmosphere.

### (8) Second Heating Step (S8)

In the second heating step (S8), the laminate is heated such that dielectric layers 11 are formed from the dielectric layer precursor sheets 71, internal electrode layers 12 are formed from the internal electrode layer patterns so that the content of copper with respect to nickel is 0.5 at % or greater and 8.5 at % or less, and oxide layers 40 having an average thickness of 1.5 nm or greater and 3.7 nm or less are formed between the dielectric layers and the internal electrode layers. Through the second heating step (S8), the content of nickel in the oxide layers 40 with respect to the content of nickel in the internal electrode layers 12 becomes 90 at % or less, and the content of oxygen in the oxide layers 40 with respect to the content of oxygen in the dielectric layers 11 becomes 90 at % or less. The second heating step (S8) is performed after the first heating step (S7).

The heating temperature in the second heating step (S8) is not particularly limited, yet it is preferable to heat the laminate at 1,100° C. or higher and 1,300° C. or lower. The heating time in the second heating step (S8) is not particularly limited, yet it is preferable to retain the laminate heated for 10 minutes or longer and 2 hours or shorter. Most of all, in the second heating step (S8), it is particularly preferable to retain the laminate, which has undergone the first heating step (S7), at a temperature of 1,100° C. or higher and 1,300° C. or lower for 10 minutes or longer and 2 hours or shorter.

The oxygen partial pressure in the second heating step (S8) is not particularly limited, yet is preferably 10⁻¹² atm or higher and 10⁻⁷ atm or lower, more preferably 10⁻¹⁰ atm or higher and 10⁻⁷ atm or lower, and yet more preferably 10⁻⁸ atm or higher and 10⁻⁷ atm or lower. As described above, since the metal paste used to form the internal electrode layer patterns contains copper oxide, the thickness of the oxide layers 40 on the internal electrode layers can be reduced even at such an oxygen partial pressure.

A preferable atmosphere condition in the second heating step (S8) is a reducing atmosphere.

### (9) Re-Oxidation Treatment Step (S9)

In the re-oxidation treatment step (S9), heat treatment is performed in a water vapor-mixed gas in a reducing atmosphere at 600° C. to 1,000° C., or in open air at 500° C. to 700° C. Thus, it is possible to return oxygen to the partially reduced main phase of the dielectric layers 11 fired in the reducing atmosphere. The re-oxidation treatment step (S9) is performed so as not to oxidize the internal electrode layer 12.

### (10) External Electrode Forming Step (S10)

In the external electrode forming step (S10), a metal paste is applied to the first side surface 10a and the second side surface 10b, which are two facing side surfaces of the laminate that is obtained in the second heating step (S8) or of the laminate that has undergone the re-oxidation treatment step (S9).

In the external electrode forming step (S10), the metal paste can be applied to the first side surface 10a and the second side surface 10b of the laminate by, for example, dipping or plating. As a result, the first external electrode 20a and the second external electrode 20b are formed.

In the external electrode forming step (S10), it is preferable to dry the metal paste after it is applied to the first side surface 10a and the second side surface 10b of the laminate.

The metal paste used in the external electrode forming step (S10) may be compositionally the same as or different from the metal paste used in the internal electrode layer pattern forming step (S4), except for the organic binder. An example of the metal paste used in the external electrode forming step (S10) is a metal paste containing nickel (Ni) as a main component, ceramic particles as a co-existing material, a powder of an additive metal element, and the like. The metal paste used in the external electrode forming step (S10) may contain a glass component. By adding the glass component, it is possible to reduce voids from the interior of the external electrodes and to enhance the strength.

### (11) Plating Treatment Step (S11)

In the plating treatment step (S11), plating treatment is performed on the exposed parts of the first external electrode 20a and the second external electrode 20b. The plating treatment is performed using metals such as copper (Cu), nickel (Ni), tin (Sn), and the like.

The multilayer ceramic capacitor 100 can be produced through the above-described steps.

The above-described steps are an example, and the method of producing the multilayer ceramic capacitor of this embodiment is not limited to the above-described mode.

### Other Embodiments

Although an embodiment has been described in detail, the present disclosure is not limited to the specific embodiment, and various modifications and changes are applicable within the scope of claims. For example, after the first external electrode 20a and the second external electrode 20b are formed after the singulation step, they can be sintered at the same time as firing the dielectric layer precursor sheets 71 in the first heating step and the second heating step. The first external electrode 20a and the second external electrode 20b can be formed also be formed in this way.

For example, although the above-described embodiment is applied to a multilayer ceramic capacitor having two terminal electrodes, it may also be applied to a multilayer ceramic capacitor having three or more terminals.

In the above-described embodiment, a multilayer ceramic capacitor is described as an example of the multilayer ceramic electronic component. However, the present disclosure is applicable to all types of multilayer ceramic electronic components in general. Examples of such multilayer ceramic electronic components include chip varistors, chip thermistors, and the like.

### Circuit Module

A circuit module of this embodiment includes the multilayer ceramic electronic component of this embodiment. A specific example of the circuit module is an electronic circuit board mounted with the multilayer ceramic capacitor 100. Various electronic components other than the multilayer ceramic capacitor 100 can also be mounted on the circuit module.

### Electronic Device

An electronic device of this embodiment includes the circuit module of this embodiment. Specific examples of the electronic device include smartphones, tablets, game consoles, electric components of automobiles, servers, and the like. However, various electronic devices other than these can be included.

### EXAMPLES

The present disclosure will be specifically described below by way of Examples and Comparative Examples. However, the present disclosure is not limited to these Examples in any way.

### Example 1

A multilayer ceramic capacitor 100 was produced according to the flowchart shown in FIG. 6.

### Raw Material Powder Preparation Step (S1) and Slurry Preparation Step (S2)

To a barium titanate powder, a polyvinyl butyral (PVB) resin as an organic binder, ethanol, toluene, dioctyl phthalate (DOP) as a plasticizer, and silicon dioxide (SiO₂) as a sintering aid were added and mixed in a wet manner, to prepare a slurry.

### Coating Step (S3)

The obtained slurry was applied to a polyethylene terephthalate (PET) film using a die coater, and dried, to produce a dielectric layer precursor sheet.

### Internal Electrode Layer Pattern Forming Step (S4)

Copper oxide dispersed in terpineol was added to a mixture of a nickel powder as a main component and a polyvinyl butyral resin as an organic binder such that the content of copper with respect to nickel would be 0.5 at % in the final product to be produced, to prepare a metal conductive paste. The metal conductive paste was printed on the dielectric layer precursor sheet by screen printing, to form an internal electrode layer pattern to be drawn out to alternate one of a pair of external electrodes, to thereby form a lamination unit. The lamination unit includes the dielectric layer precursor sheet and the internal electrode layer pattern formed on the surface of the dielectric layer precursor sheet.

### Laminate Forming Step (S5)

While peeling the PET film from the dielectric layer precursor sheet, four hundred lamination units were laminated, to form a laminated product. Furthermore, after five cover layers were laminated on each of the upper and lower surfaces of the lamination unit laminated product, and they were thermo-compression bonded, to form a laminate. The composition of the cover layers was the same as the dielectric layer precursor sheet.

### Singulation Step (S6)

The laminate was singulated into individual pieces having a length of 1.0 mm, a width of 0.5 mm, and a height of 0.5 mm by dicing, to obtain a chip-shaped laminate (hereinafter, may be referred to as “ceramic laminate precursor”).

### First Heating Step (S7)

The ceramic laminate precursor was fired at 950° C. for 5 minutes in a reducing atmosphere at an oxygen partial pressure of 10⁻⁷ atm.

### Second Heating Step (S8)

Next, the ceramic laminate precursor was fired at 1,200° C. for 1 hour in a reducing atmosphere at an oxygen partial pressure of 10⁻⁷ atm.

### Re-Oxidation Treatment Step (S9)

After the second heating step (S8), the re-oxidation treatment was further performed at 900° C. in a nitrogen gas atmosphere.

### External Electrode Forming Step (S10)

Plating treatment was performed on the first side surface 10a and the second side surface 10b, which were two facing side surface of the laminate that had undergone the re-oxidation treatment step (S9), with nickel (Ni), to form the first external electrode 20a and the second external electrode 20b.

Through the above, a multilayer ceramic capacitor 100 having a chip shape having a length of 1.0 mm, a width of 0.5 mm, and a height of 0.5 mm, having an average dielectric layer 11 thickness of 0.4 μm, an average internal electrode layer 12 thickness of 0.6 μm, and an average oxide layer 40 thickness of 3.64 nm, and including four hundred layers of lamination units was produced.

### Examples 2 to 8 and Comparative Examples 1 to 3

Multilayer ceramic capacitors of Examples 2 to 8 and Comparative Examples 1 to 3 were produced in the same manner as in Example 1 except that the amount of copper oxide added in the internal electrode layer pattern forming step (S4) of Example 1 was changed such that the content of copper with respect to nickel would be as shown in Table 1 below in the final product to be produced.

### Comparative Examples 4 to 7

Multilayer ceramic capacitors of Comparative Examples 4 to 7 were produced in the same manner as in Example 1 except that unlike Example 1, the first heating step (S7) was not performed and the second heating step (S8) was performed after the singulation step (S6).

The multilayer ceramic capacitors of Examples 1 to 8 and Comparative Examples 1 to 7 were subjected to “Measurement of Content of Cu with Respect to Ni in Internal Electrode Layer”, “Measurement of Average Thickness of Oxide Layers”, “Measurement and Evaluation of Capacitance”, and “Measurement and Evaluation of Reliability” according to the following methods. The evaluation results are shown in Table 1 below.

### Measurement of Content of Cu with Respect to Ni in Internal Electrode Layer

The multilayer ceramic capacitors 100 of Examples 1 to 8 and Comparative Examples 1 to 7 were each polished along the Y axis, and polished to the center on the Y axis, to prepare a sample that exposed an XZ surface in which the dielectric layers 11 and the internal electrode layers 12 were laminated. From the exposed XZ surface, two internal electrode layers 12 located in the center on the Z axis, which was the first axis, were selected, and two internal electrode layers 12 located at each of the upper and lower ends on the Z axis, which was the first axis, were further selected. Here, the internal electrode layers 12 to be selected were selected from within the capacitive part 14.

The contents of nickel, copper, and other components in the internal electrode layer 12 were measured by an elemental analysis at each measurement position using an Energy Dispersive X-ray Spectrometer (EDS) mounted on a Scanning Electron Microscope (SEM). Based on the amounts (at %) of Cu and Ni among the measurement results obtained for the respective elements, the ratio of Cu to Ni, which was regarded as 100, was calculated. The average of the results obtained at the respective measurement positions were calculated as the content of Cu with respect to Ni in the internal electrode layers of the sample.

### Measurement of Average Thickness of Oxide Layers

The multilayer ceramic capacitors 100 of Examples 1 to 8 and Comparative Examples 1 to 7 were each polished along the Y axis, and polished to the center on the Y axis, to prepare samples that exposed an XZ surface in which the dielectric layers 11 and the internal electrode layers 12 were laminated. From the exposed XZ surface, two dielectric layers 11 located in the center on the Z axis, which was the first axis, were selected, and two dielectric layers 11 located at each of the upper and lower ends on the Z axis, which was the first axis, were selected. Here, the dielectric layers 11 to be selected were selected from within the capacitive part 14.

For each selected dielectric layer 11, a conical region having a bottom circle diameter of 100 nm and a height of 400 nm was cut out from a part including the dielectric layer 11-internal electrode layer 12 interface in the center on the X axis, which was the second axis, using a Focused Ion Beam (FIB) device (obtained from FEI Company), and used as a sample for measuring the average thickness of the oxide layers 40.

An elemental analysis of the measurement sample was performed by measuring the sample from the dielectric layer 11 side to the internal electrode layer 12 side using a three-dimensional atom probe (LEAP5000XS, AMETEK) in a measurement mode of Laser Pulse, at a laser wavelength of 355 nm, to determine the distribution of the elements inside the measurement sample three-dimensionally at the atomic level. The thickness of the oxide layers 40 was evaluated, using profile data of the respective elements in the direction from the dielectric layer 11 side to the internal electrode layer 12 side, obtained by the measurement.

Regarding the O concentration, an average value c(A) of the O concentration in a range from the position A of the end from where the measurement was started to a position (A+0.5) reached by bringing forward the measurement by 0.5 nm, that is, a range from the position at the measurement distance of d(A) [nm] to the position at the measurement distance of d(A+0.5) [nm], was calculated. A concentration that was 90% the average value c(A) of the O concentration was defined as c(B). A position B having this concentration c(B) was a position at the measurement distance of d(B) [nm]. This position B was defined as the boundary between the dielectric layer 11 and the oxide layer 40, and referred to as “interface I”.

Regarding the Ni concentration, an average value c(C) of the Ni concentration in a range from the position N of the end at which the measurement was finished to a position (N−0.5) reached by returning to the dielectric layer 11 side by 0.5 nm, that is, a range from the position at the measurement distance of d(N) [nm] to the position at the measurement distance of d(N−0.5) [nm], was calculated. A concentration that was 90% the average value c(C) of the Ni concentration was defined as c(D). A position C having this concentration c(D) was a position at the measurement distance of d(C) [nm]. This position C was defined as the boundary between the oxide layer 40 and the internal electrode layer 12, and referred to as “interface II”.

Next, by regarding the range from the interface I to the interface II as an “oxide layer 40”, the thickness of the oxide layer 40 was calculated based on the profile data of the respective elements in the direction from the dielectric layer 11 side to the internal electrode layer 12 side obtained by the measurement.

By the same procedure, the thickness of the oxide layer 40 was measured for the boundaries between all of the selected six dielectric layers 11 and internal electrode layers 12, and the average value of the thickness values of these oxide layers 40 was calculated as “Average thickness of oxide layers”.

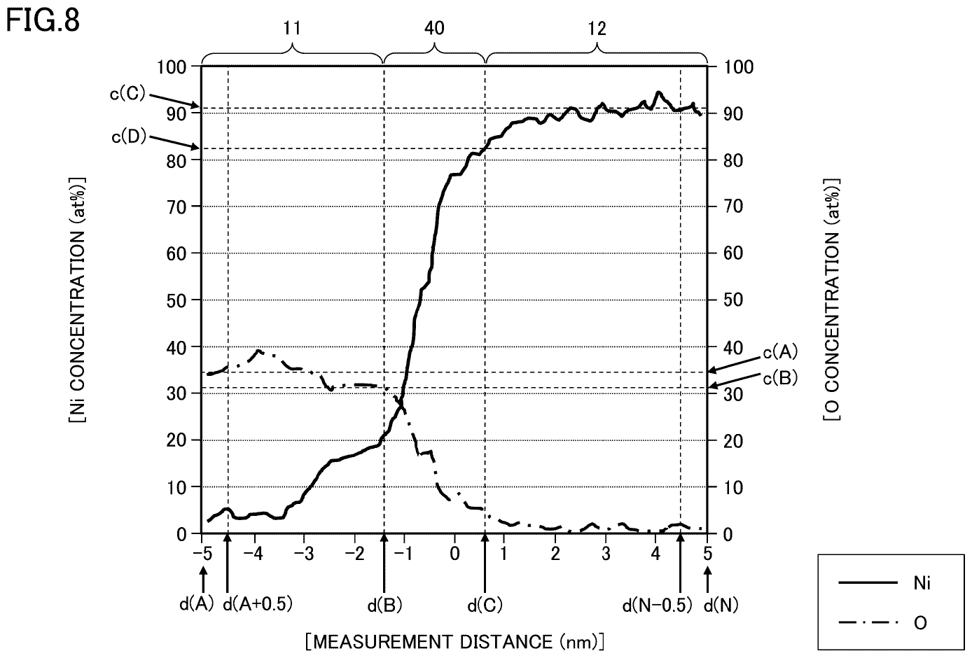

FIG. 8 shows the measurement results of Example 6 as an example of the measurement results of the three-dimensional atom probe analysis. By performing the three-dimensional atom probe analysis, the content ratio between the elements contained in the dielectric layer 11, the internal electrode layer 12, and the oxide layer 40 can be measured and calculated.

From graphs of copper oxide (CuO) contained in the internal electrode layer 12 and oxygen (O) due to oxidation during firing among the measurement results, the average value c(A) of the O concentration in the range from the position A of the end from where the measurement was started to the position (A+0.5) reached by bringing forward the measurement by 0.5 nm, that is, the range from the position at the measurement distance of d(A) [nm] to the position at the measurement distance of d(A+0.5) [nm], was calculated. A concentration that was 90% the average value c(A) of the O concentration was defined as c(B). The position B having this concentration c(B) was a position at the measurement distance of d(B) [nm]. This position B was defined as the boundary between the dielectric layer 11 and the oxide layer 40, and an “interface I” was derived. Further, from the graph attributable to nickel (Ni) contained in the internal electrode layer 12 as a main component, the average value c(C) of Ni concentration in the range from the position N of the end at which the measurement was finished to the position (N−0.5) reached by returning to the dielectric layer 11 side by 0.5 nm, that is, the range from the position at the measurement distance of d(N) [nm] to the position at the measurement distance of d(N−0.5) [nm], was calculated. A concentration that was 90% the average value c(C) of Ni concentration was defined as c(D). The position C having this concentration c(D) was a position at the measurement distance of d(C) [nm]. This position C was defined as the boundary between the oxide layer 40 and the internal electrode layer 12, and an “interface II” was derived.

### Measurement and Evaluation of Capacitance

After the multilayer ceramic capacitors of Examples 1 to 8 and Comparative Examples 1 to 7 were left to stand at 150° C. for 1 hour and left to stand at standard state for 24 hours, the capacitance was measured using an LCR meter (obtained from Keysight Technologies Inc. (Agilent)) at 0.5 V-1 kHz conditions. Regarding the capacitance of the multilayer ceramic capacitor of Comparative Example 1 as 100%, the ratio of the capacitance of the multilayer ceramic capacitors of Examples 1 to 8 and Comparative Examples 2 to 7 to the capacitance of Comparative Example 1 was calculated. Based on this ratio, the capacitance was evaluated according to the following evaluation criteria.

### Evaluation Criteria for Capacitance

A (pass): The capacitance of the measurement sample was equal to or greater than 80% the capacitance of the multilayer ceramic capacitor of Comparative Example 1.

B (pass): The capacitance of the measurement sample was equal to or greater than 65% and less than 80% the capacitance of the multilayer ceramic capacitor of Comparative Example 1.

C (fail): The capacitance of the measurement sample was less than 65% the capacitance of the multilayer ceramic capacitor of Comparative Example 1.

### Measurement and Evaluation of Mean Time to Failure (MTTF)

The multilayer ceramic capacitors of Examples 1 to 8 and Comparative Examples 1 to 7 were subjected to an accelerated life test in which a voltage of 9 V/μm was applied at 125° C. For each of the multilayer ceramic capacitors of Examples 1 to 8 and Comparative Examples 1 to 7, the mean time to failure (MTTF) of twenty measurement samples was measured, and evaluated according to the following evaluation criteria.

### MTTF Evaluation Criteria

A (pass): The MTTF was 2,000 minutes or longer.

B (pass): The MTTF was 1,000 minutes or longer and shorter than 2,000 minutes

C (fail): The MTTF was shorter than 1,000 minutes

### Comprehensive Evaluation

Based on the capacitance ratio and the mean time to failure (MTTF), the value of the following expression (1) was calculated and evaluated according to the following evaluation criteria. This was used as the comprehensive evaluation.

Reliability×(Capacitance/100)² [Expression 1]

### Evaluation Criteria for Comprehensive Evaluation

A (pass): The value calculated by the expression 1 was 1,500 or greater.

B (pass): The value calculated by the expression 1 was 1,200 or greater and less than 1,500.

C (fail): The value calculated by the expression 1 was less than 1,200.

TABLE 1

| | | | Ave. | | | | | | |
|---|---|---|---|---|---|---|---|---|---|
| | Content | | thick. | Capacitance | | | | Reliability × | |
| | of Cu | 1^{st} | of oxide | Ratio to | | Reliability | | (capacitance/100)² | |
| | wrt Ni | heating | layers | Comp. Ex. | Evaluation | MTTF | Evaluation | Calculated | Evaluation |
| | [at %] | step | [nm] | 1 [%] | result | [min] | result | value | result |
| Comp. | 0 | Present | 3.85 | 100 | — | 1,000 | B | 1,000 | — |
| Ex. 1 | | | | | | | | | |
| Comp. | 0.2 | Present | 3.78 | 97 | A | 980 | C | 922 | C |
| Ex. 2 | | | | | | | | | |
| Ex. 1 | 0.5 | Present | 3.64 | 110 | A | 1,100 | B | 1,331 | B |
| Ex. 2 | 0.7 | Present | 3.50 | 103 | A | 1,300 | B | 1,379 | B |
| Ex. 3 | 1.2 | Present | 3.45 | 101 | A | 2,000 | A | 2,040 | A |
| Ex. 4 | 2.2 | Present | 3.00 | 96 | A | 2,200 | A | 2,028 | A |
| Ex. 5 | 3.1 | Present | 2.70 | 90 | A | 2,600 | A | 2,106 | A |
| Ex. 6 | 5.1 | Present | 2.00 | 91 | A | 2,700 | A | 2,236 | A |
| Ex. 7 | 5.6 | Present | 2.38 | 82 | A | 3,000 | A | 2,017 | A |
| Ex. 8 | 8.5 | Present | 1.52 | 68 | B | 3,100 | A | 1,433 | B |
| Comp. | 11.0 | Present | 1.00 | 60 | B | 3,200 | A | 1,152 | C |
| Ex. 3 | | | | | | | | | |
| Comp. | 0.5 | Absent | 3.89 | 98 | A | 988 | C | 949 | C |
| Ex. 4 | | | | | | | | | |
| Comp. | 0.7 | Absent | 3.79 | 96 | A | 992 | C | 914 | C |
| Ex. 5 | | | | | | | | | |
| Comp. | 2.2 | Absent | 3.90 | 91 | A | 980 | C | 812 | C |
| Ex. 6 | | | | | | | | | |
| Comp. | 11.0 | Absent | 3.55 | 57 | C | 1,045 | B | 340 | C |
| Ex. 7 | | | | | | | | | |

The content of copper with respect to nickel in the internal electrode layer 12 is the same in each pair of Example 1 and Comparative Example 4, Example 2 and Comparative Example 5, and Example 4 and Comparative Example 6. However, Comparative Examples 4 to 6 skipped the first heating step, resulting in a large thickness of the oxide layers 40, and it was confirmed that both of reliability and capacitance were not achieved.

Although including the first heating step, Comparative Example 2, in which the content of copper with respect to nickel was less than that in Example 1, is considered to have had an insufficient amount of copper migration through the first heating step, because the content of copper with respect to nickel in the internal electrode layer 12 was small. It is considered that reliability could not be improved as a result.

Although including the first heating step, Comparative Example 3, in which the content of copper with respect to nickel in the internal electrode layer 12 was excessive, is considered to have had a large amount of copper migration through the first heating step. As a result, the thickness of the oxide layers 40 became small, and it is considered that reliability and capacitance could not both be achieved as a result.

Although the content of copper with respect to nickel in the internal electrode layer 12 was the same in Comparative Example 3 and Comparative Example 7, Comparative Example 7 including no first heating step resulted in a large thickness of the oxide layers 40, and was confirmed to fail in achieving both reliability and capacitance.

These results indicate that an appropriate amount of migration of copper in the internal electrode layer 12 that had occurred through the first heating step is crucial for achieving both reliability and capacitance. Appropriate adjustment of the content of copper with respect to nickel in the internal electrode layer 12 after being subjected to firing including the first heating step enables the oxide layers 40 to have an appropriate thickness after firing.

It is preferable that the content of copper with respect to nickel in the internal electrode layer 12 after being subjected to firing including the first heating step is 0.5 at % or greater and 8.5 at % or less, and the average thickness of the oxide layers 40 is 1.5 nm or greater and 3.7 nm or less, because capacitance and reliability can both be achieved. In order to realize high capacitance, the content of copper with respect to nickel is preferably 0.5 at % or greater and 6.0 at % or less, and the average thickness of the oxide layers is preferably 2.0 nm or greater and 3.7 nm or less. In order to realize high capacitance and high reliability, the content of copper with respect to nickel is more preferably 1.0 at % or greater and 6.0 at % or less, and the average thickness of the oxide layers is preferably 2.0 nm or greater and 3.45 nm or less.

As described above, the present disclosure has been described based on specific embodiments and Examples. However, these embodiments and Examples are presented only as examples, and the present disclosure is not limited to the above embodiments and Examples. The above embodiments can be implemented in various other forms, and various combinations, omissions, substitutions, additions, modifications, and the like are applicable without departing from the spirit of the invention. These embodiments and modifications thereof are included in the scope and spirit of the invention, and are also included in the scope of the invention described in the claims and the equivalents thereof.

Aspects of the present disclosure are, for example, as follows.

<1> A multilayer ceramic electronic component, including:
a plurality of dielectric layers laminated along a first axis;
a plurality of internal electrode layers each positioned between those of the dielectric layers that adjoin each other along the first axis; and
oxide layers positioned between the dielectric layers and the internal electrode layers,
wherein the dielectric layers contain a compound having a perovskite structure represented by a general formula ABO_{3-α} (0≤α≤1),
the internal electrode layers contain nickel and copper, and a content of the copper with respect to the nickel in the internal electrode layers is 0.5 at % or greater and 8.5 at % or less,
a content of nickel in the oxide layers with respect to a content of the nickel in the internal electrode layers is 90 at % or less, and a content of oxygen in the oxide layers with respect to a content of oxygen in the dielectric layers is 90 at % or less, and
an average thickness of the oxide layers is 1.5 nm or greater and 3.7 nm or less.
   <2> The multilayer ceramic electronic component according to <1>,
wherein a mean time to failure of twenty multilayer ceramic electronic components, each of which is the multilayer ceramic electronic component, measured in an accelerated life test in which a voltage of 9 V/μm is applied at 125° C. and a capacitance of the multilayer ceramic electronic component satisfy an expression 1 below,

Mean time to failure×(Capacitance/100)²≥1,200. [Expression 1]

<3> The multilayer ceramic electronic component according to <1> or <2>,
wherein the dielectric layers contain barium titanate as the compound having the perovskite structure.
   <4> A circuit module, including:
the multilayer ceramic electronic component of any of <1> to <3>.
   <5> An electronic device, including:
the circuit module of <4>.
   <6> A method of producing a multilayer ceramic electronic component, the method including:
forming an internal electrode layer pattern on a dielectric layer precursor sheet by using a metal paste containing nickel, copper oxide, and an organic binder, the dielectric layer precursor sheet containing a raw material powder of a ceramic material containing a compound having a perovskite structure represented by general formula ABO_{3-α} (0≤α≤1);
forming a laminate in which a plurality of dielectric layer precursor sheets are laminated along a first axis, each of the plurality of dielectric layer precursor sheets being the dielectric layer precursor sheet on which the internal electrode layer pattern is formed;
firstly heating the laminate at a temperature that is equal to or higher than a degreasing temperature at which the organic binder is degreased and is lower than a firing temperature; and
   secondly heating the laminate such that
      dielectric layers are formed from the dielectric layer precursor sheets,
      internal electrode layers are formed from internal electrode layer patterns, each of which is the internal electrode layer pattern, so as to have a content of copper of 0.5 at % or greater and 8.5 at % or less with respect to the nickel, and
      oxide layers having an average thickness of 1.5 nm or greater and 3.7 nm or less are formed between the dielectric layers and the internal electrode layers,
wherein a content of nickel in the oxide layers with respect to a content of the nickel in the internal electrode layers is 90 at % or less, and a content of oxygen in the oxide layers with respect to a content of oxygen in the dielectric layers is 90 at % or less.
   <7> The method of producing a multilayer ceramic electronic component according to <6>,
wherein in the firstly heating, the laminate is retained at 800° C. or higher and 1,000° C. or lower for 3 minutes or longer and 5 minutes or shorter.
   <8> The method of producing a multilayer ceramic electronic component according to <6> or <7>,
wherein the secondly heating is performed under an atmosphere having an oxygen partial pressure of 10⁻¹² atm or higher and 10⁻⁷ atm or lower.

What is claimed is:

1. A multilayer ceramic electronic component, comprising:
a plurality of dielectric layers laminated along a first axis;
a plurality of internal electrode layers each positioned between those of the dielectric layers that adjoin each other along the first axis; and
oxide layers positioned between the dielectric layers and the internal electrode layers,
wherein the dielectric layers contain a compound having a perovskite structure represented by a general formula ABO_{3-α} (0≤α≤1),
the internal electrode layers contain nickel and copper, and a content of the copper with respect to the nickel in the internal electrode layers is 0.5 at % or greater and 8.5 at % or less,
a content of nickel in the oxide layers with respect to a content of the nickel in the internal electrode layers is 90 at % or less, and a content of oxygen in the oxide layers with respect to a content of oxygen in the dielectric layers is 90 at % or less, and
an average thickness of the oxide layers is 1.5 nm or greater and 3.7 nm or less.

2. The multilayer ceramic electronic component according to claim 1,
wherein a mean time to failure of twenty multilayer ceramic electronic components, each of which is the multilayer ceramic electronic component, measured in an accelerated life test in which a voltage of 9 V/μm is applied at 125° C. and capacitance of the multilayer ceramic electronic component satisfy an expression 1 below,
Mean time to failure×(Capacitance/100)²≥1,200. [Expression 1]

3. The multilayer ceramic electronic component according to claim 1,
wherein the dielectric layers contain barium titanate as the compound having the perovskite structure.

4. A circuit module, comprising:
the multilayer ceramic electronic component of claim 1.

5. An electronic device, comprising:
the circuit module of claim 4.

6. A method of producing a multilayer ceramic electronic component, the method comprising:
forming an internal electrode layer pattern on a dielectric layer precursor sheet by using a metal paste containing nickel, copper oxide, and an organic binder, the dielectric layer precursor sheet containing a raw material powder of a ceramic material containing a compound having a perovskite structure represented by a general formula ABO_{3-α} (0≤α≤1);
forming a laminate in which a plurality of dielectric layer precursor sheets are laminated along a first axis, each of the plurality of dielectric layer precursor sheets being the dielectric layer precursor sheet on which the internal electrode layer pattern is formed;
firstly heating the laminate at a temperature that is equal to or higher than a degreasing temperature at which the organic binder is degreased and is lower than a firing temperature; and
secondly heating the laminate such that
dielectric layers are formed from the dielectric layer precursor sheets,
internal electrode layers are formed from internal electrode layer patterns, each of which is the internal electrode layer pattern, so as to have a content of copper of 0.5 at % or greater and 8.5 at % or less with respect to the nickel, and
oxide layers having an average thickness of 1.5 nm or greater and 3.7 nm or less are formed between the dielectric layers and the internal electrode layers,
wherein a content of nickel in the oxide layers with respect to a content of the nickel in the internal electrode layers is 90 at % or less, and a content of oxygen in the oxide layers with respect to a content of oxygen in the dielectric layers is 90 at % or less.

7. The method of producing a multilayer ceramic electronic component according to claim 6,
wherein in the firstly heating, the laminate is retained at 800° C. or higher and 1,000° C. or lower for 3 minutes or longer and 5 minutes or shorter.

8. The method of producing a multilayer ceramic electronic component according to claim 6,
wherein the secondly heating is performed under an atmosphere having an oxygen partial pressure of 10⁻¹² atm or higher and 10⁻⁷ atm or lower.
